(19) United States
(12) Patent Application Publication
(10) Pub. No.: US 2008/0271576 A1
(43) Pub. Date: Nov. 6, 2008

(54) Socket connection device of adjustable tension value for preventing overlarge twisting force

(76) Inventor: Chih-Ching Hsieh, Taichung City (TW)

Correspondence Address: Chih-Ching Hsieh, 235 Chung-Ho, Box 8-24, Taipei, TW

(21) Appl. No.: 11/799,482

(22) Filed: May 2, 2007

(51) Int. Cl. B25B 13/06; F16D 3/00

(52) U.S. Cl. 81/121.1; 464/61.1

(57) ABSTRACT

A socket connection device of adjustable tension value for preventing an overlarge twisting force comprises a seat having a receiving space which penetrates through an upper and a lower end of the seat; one end of the seat being an engaging portion for engaging a spanner or a driving tool; another end of the seat being a hole section; a middle part of the receiving space between the engaging portion and the polygonal hole section being a threaded section; the control section including an adjusting block, an elastic unit, and a buckle block; and a head formed as a long rod; one end of the head being a buckling end having a shape corresponding to that of the buckle block; an outer periphery of the head near the buckling end being formed with an annular groove; and another end of the head opposite to the buckling end is an engaging end.

### FIELD OF THE INVENTION

The present invention relates to hand tools, and particularly to a hand tool with a socket connection device of adjustable tension value for preventing an overlarge twisting force wherein the tension for topping the spanner from the operation of a screw device is adjustable so as to provide a safety operation.

### BACKGROUND OF THE INVENTION

A socket is used to drive a screw unit so as to extend the operation range of the tool. One end of the socket is connected to a driving tool, such as a spanner or a dynamic tool, and another end of the socket is connected to a screw.

However in some application, a connecting device is further added to the socket and then the connecting device is used to be connected to a screw device.

In one prior art, the socket is extendable and the upper end and lower end of the socket are used to lock another object. If the lower end of the socket is rotated, the elastic unit is driven so as to change the set tension value for stopping the spanner from the operation of a screw device so as not to destroy the screw device.

In this prior art, the lower end of the socket has an engaging hole for being connected to a driven unit, such as a spanner or a dynamic tool. However in operating the socket for driving the screw device, the lower end of the socket is still possible to rotate with respect to the upper end of the socket and thus the set value of the tension is possibly changed.

Moreover, in adjustment of the set tension value, the rotation of the lower end of the socket will cause the elastic unit to deform and for a long time, the socket is useless.

### SUMMARY OF THE INVENTION

Accordingly, the primary object of the present invention is to provide a socket connection device of adjustable tension value for preventing an overlarge twisting force wherein the tension for stopping the spanner from the operation of a screw device is adjustable so as to provide a safety operation.

To achieve above objects, the present invention provides a socket connection device of adjustable tension value for preventing an overlarge twisting force comprising: a seat having an approximate round cylinder; the seat having a receiving space which penetrates through an upper and a lower end of the seat; one end of the seat being an engaging portion for engaging a spanner or a driving tool; another end of the seat being a hole section; an opening of the hole section being an engaging groove; a middle part of the receiving space between the engaging portion and the polygonal hole section being a threaded section; the control section including an adjusting block, an elastic unit, and a buckle block; an outer side of the adjusting block having threads for screwing with the threaded section of the receiving space of the seat; an upper side of the adjusting block being formed with a polygonal adjusting groove which faces the engaging portion for receiving a spanner or other driving means to drive the adjusting block; two ends of the elastic unit resisting against the adjusting block and the buckle block so as to provide an elastic force to the buckle block; the buckle block being received in the hole section of the receiving space; an outer shape of the buckle block being corresponding to that of the polygonal hole section so that the buckle block is not rotated with respect to the receiving space; and a head formed as a long rod; one end of the head being a buckling end having a shape corresponding to that of the buckle block; an outer periphery of the head near the buckling end being formed with an annular groove; and another end of the head opposite to the buckling end is an engaging end.

The various objects and advantages of the present invention will be more readily understood from the following detailed description when read in conjunction with the appended drawing.

### BRIEF DESCRIPTION OF THE DRAWINGS

FIG. 1 is a schematic perspective view of the socket connection device of adjustable tension value for preventing an overlarge twisting force of the present invention.

FIG. 2 is a perspective view of the socket connection device of adjustable tension value for preventing an overlarge twisting force of the present invention.

FIG. 3 is a schematic cross sectional view of the socket connection device of adjustable tension value for preventing an overlarge twisting force of the present invention.

FIG. 4 is a schematic view showing the adjustment of the present invention.

FIG. 5 is a schematic view showing the use of the present invention.

FIG. 6 shows the second embodiment of the present invention.

FIG. 7 shows the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

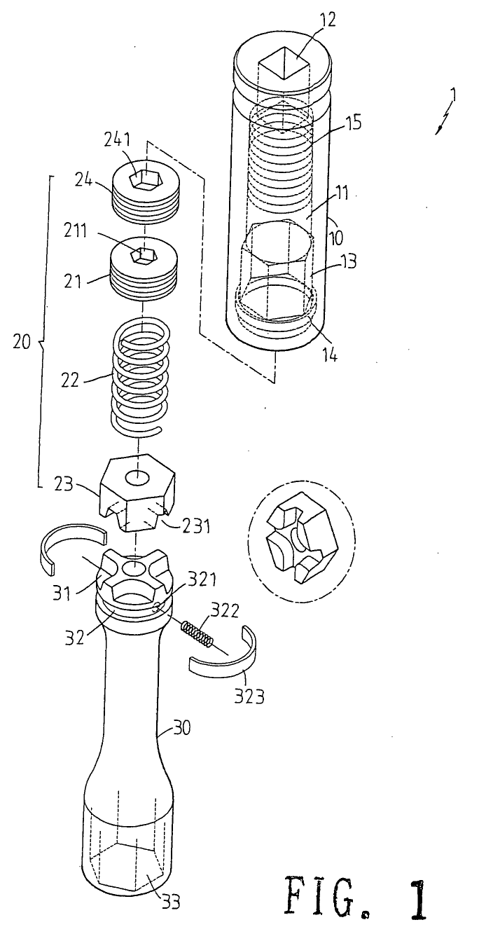

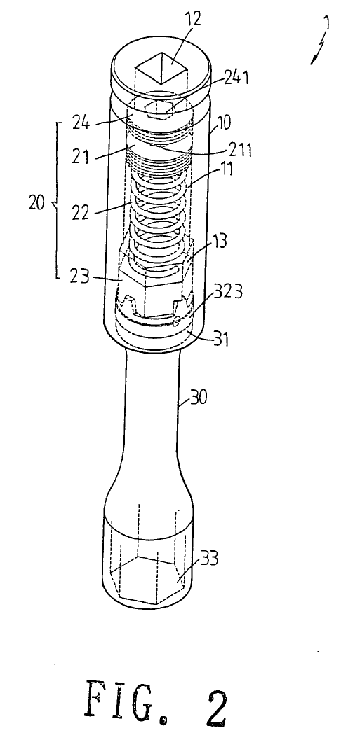

Referring to FIGS. 1 to 2, the tension socket connecting device of the present invention is illustrated. The present invention has the following elements.

A seat 10 has an approximate round cylinder. The seat 10 has a receiving space 11 which penetrates through an upper and a lower end of the seat 10. One end of the seat 10 is an engaging portion 12 for engaging a spanner or a driving tool. Another end of the seat 10 is a polygonal hole section 13. An opening of the polygonal hole section 13 is an engaging groove 14. A middle part of the receiving space 11 between the engaging portion 12 and the polygonal hole section 13 is a threaded section 15.

The control section 20 includes an adjusting block 21, an elastic unit 22, a buckle block 23 and a washer 24. An outer side of the adjusting block 21 has threads for screwing with the threaded section 15 of the receiving space 11 of the seat 10. An upper side of the adjusting block 21 is formed with a polygonal adjusting groove 211 which faces the engaging portion 12 for receiving a spanner or other driving means to drive the adjusting block 21. Two ends of the elastic unit 22 resist against the adjusting block 21 and the buckle block 23 so as to provide an elastic force to the buckle block 23. The buckle block 23 is received in the polygonal hole section 13 of the receiving space 11. An outer shape of the buckle block 23 is corresponding to that of the polygonal hole section 13 so that the buckle block 23 is not rotated with respect to the receiving space 11. A lower side of the buckle block 23 facing to the opening of the polygonal hole section 13 is formed with a cruciform recessed area 231. The inner wall of the recessed area 231 is inclined, in that an upper side of the recessed area 231 has a smaller area and a lower side of the recessed area 231 has a larger area as illustrated in a partial view of FIG. 1. The washer 24 has a through hole 24 which has a size larger than the adjusting groove 211 of the adjusting block 21. The washer 24 serves for buffering the adjusting block 21 and causing a spanner or a dynamic tool to pass therethrough.

A head 30 is formed as a long rod. One end of the head 30 is a buckling end 31 having a shape corresponding to that of the buckle block 23. An outer periphery of the head 30 near the buckling end 31 is formed with an annular groove 32. A through hole 321 is formed in the annular groove 32 for receiving an elastic body 322. Two C shape rings 323 are engaged in the annular groove 32 and also in the engaging groove 14 of the seat 10 so as to rotatably engage the head 30 to the seat 10. Another end of the head 30 opposite to the buckling end 31 is an engaging end 33. In this embodiment, the engaging end 33 is a polygonal hole for receiving a screw means.

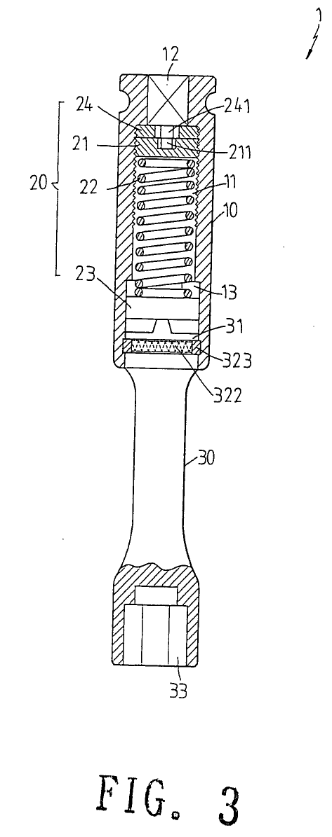

Referring to FIGS. 2 and 3, the assembly views of the present invention are illustrated. The adjusting block 21 is screwed to the threaded section 15 of the receiving space 11 of the seat 10. The adjusting groove 211 of the adjusting block 21 faces to the engaging portion 12 so that a spanner or a dynamic tool can pass through the through hole. When the adjusting block 21 is driven to move, the distance between the adjusting block 21 and the buckle block 23 will change so that the tension from the elastic unit 23 to the buckle block 23 will change. The elastic unit 22 will tighten the buckling end 31 having a shape corresponding to the recessed area 231 of the buckle block 23. When driving a screw unit by rotating the engaging end 33 of the head 30, as the tension applied to the head 30 over a predetermined value, the buckle block 23 will slide with respect to the buckling end 31 so as to disengage the screw from the socket.

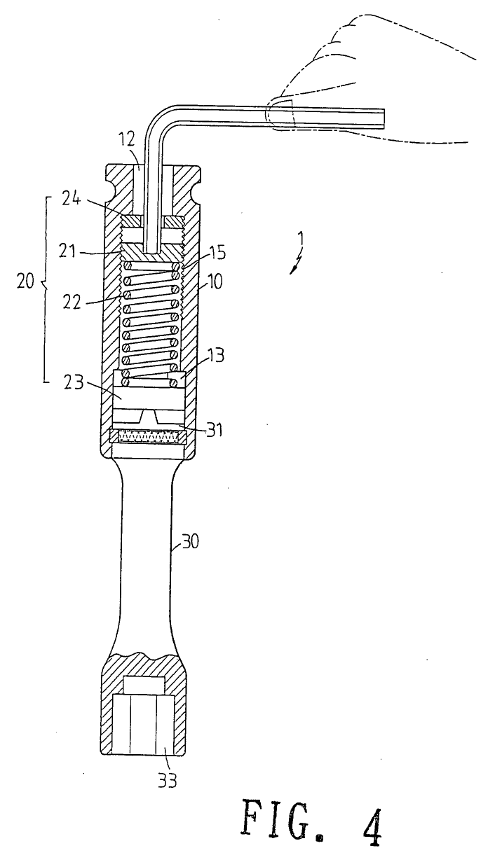

In use of the present invention, see FIG. 4, the engaging portion 12 of the seat 10 serves to assembly a spanner or a driving tool. The spanner and tool also inserts into the adjusting groove 211 of the adjusting block 21 so as to achieve the object of setting the value of the tension for stopping the spanner or the driving tool. Furthermore, the adjusting block 21 for setting the tension is installed within the seat 10, it will not be touched carelessly so as not to change the set value. The tension value is changed only when it is necessary to be changed.

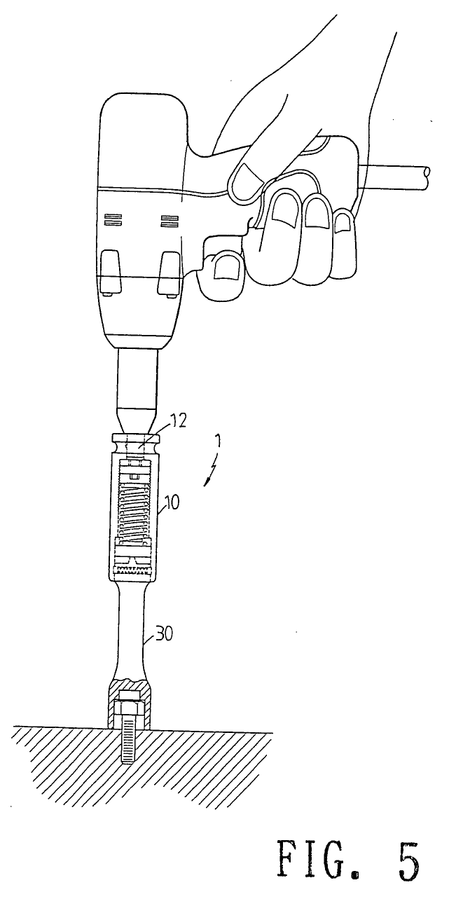

In use of the present invention, see FIG. 5, after setting the tension value, the engaging portion 12 of the seat 10 serves to assembly a spanner or a driving tool. Herein, an electromotive tool is used. The engaging end 33 of the head 30 is directly engaged with a screw unit so that the screw unit can be driven by the spanner of the present invention. Moreover, when the tension is too larger, it will stop so as to avoid the screw unit to be destroyed.

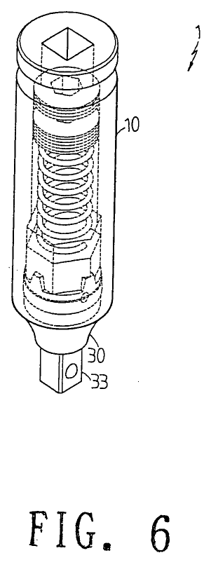

Referring to FIG. 6, the second embodiment of the present invention is illustrated. In this embodiment, those identical to the above embodiment will not be further described herein. Only those different from above embodiment are described. In this embodiment, the engaging end 33 of the head 30 is a protruded polygonal block for assembly a socket of various sizes.

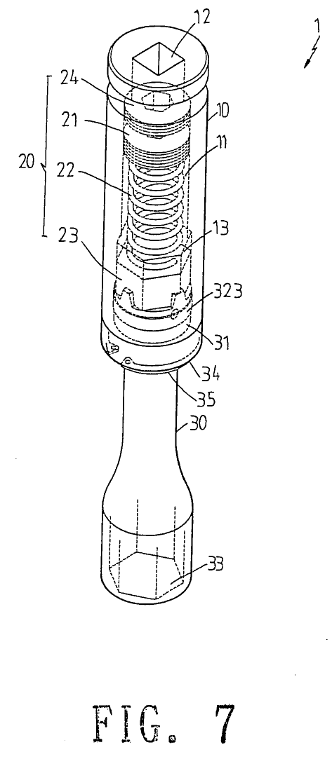

Referring to FIG. 7, the third embodiment of the present invention is illustrated. In this embodiment, those identical to the first embodiment will not be further described herein. Only those different from above embodiment are described. An outer side of the head 30 is installed with a bearing 34 which is positioned by using a ring 35. In use, the user can hold the bearing 34 so that the hand will not be affected by the rotation and thus the user can hold it steadily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A socket connection device of adjustable tension value for preventing an overlarge twisting force comprising:
a seat having an approximate round cylinder; the seat having a receiving space which penetrates through an upper and a lower end of the seat; one end of the seat being an engaging portion for engaging a spanner or a driving tool; another end of the seat being a hole section; an opening of the hole section being an engaging groove; a middle part of the receiving space between the engaging portion and the polygonal hole section being a threaded section;
a control section including an adjusting block, an elastic unit, and a buckle block; an outer side of the adjusting block having threads for screwing with the threaded section of the receiving space of the seat; an upper side of the adjusting block being formed with a polygonal adjusting groove which faces the engaging portion for receiving a spanner or other driving means to drive the adjusting block; two ends of the elastic unit resisting against the adjusting block and the buckle block so as to provide an elastic force to the buckle block; the buckle block being received in the hole section of the receiving space; an outer shape of the buckle block being corresponding to that of the polygonal hole section so that the buckle block is not rotated with respect to the receiving space; and
a head formed as a long rod; one end of the head being a buckling end having a shape corresponding to that of the buckle block; an outer periphery of the head near the buckling end being formed with an annular groove; and another end of the head opposite to the buckling end is an engaging end.

2. The socket connection device of adjustable tension value for preventing an overlarge twisting force as claimed in claim 1, wherein the engaging end is a protruded polygonal block or a recessed groove.

3. The socket connection device of adjustable tension value for preventing an overlarge twisting force as claimed in claim 1, wherein the buckle block has a cruciform recess.

4. The socket connection device of adjustable tension value for preventing an overlarge twisting force as claimed in claim 1, wherein the receiving space has a polygonal hole section and the buckle block has a polygonal shape.

5. The socket connection device of adjustable tension value for preventing an overlarge twisting force as claimed in claim 1, wherein an opening of the polygonal hole section has an engaging groove; a through hole is formed in the annular groove for receiving an elastic body; two C shape rings are engaged in the annular groove and also in the engaging groove of the seat so as to rotatably engage the head to the seat.

6. The socket connection device of adjustable tension value for preventing an overlarge twisting force as claimed in claim 1, wherein the inner wall of the recessed area is inclined.

7. The socket connection device of adjustable tension value for preventing an overlarge twisting force as claimed in claim 1, wherein an upper side of the recessed area has a smaller area and a lower side of the recessed area has a larger area.

8. The socket connection device of adjustable tension value for preventing an overlarge twisting force as claimed in claim 1, wherein a washer is installed at an upper side of the adjusting block; and the washer has a through hole which has a size larger than the adjusting groove of the adjusting block.

9. The socket connection device of adjustable tension value for preventing an overlarge twisting force as claimed in claim 1, wherein an outer side of the head is installed with a bearing which is positioned by using a ring.
